(19) United States
(12) Patent Application Publication
(10) Pub. No.: US 2014/0168261 A1
(43) Pub. Date: Jun. 19, 2014

(54) DIRECT INTERACTION SYSTEM MIXED REALITY ENVIRONMENTS

(71) Applicants: Jeffrey N. Margolis, Seattle, WA (US); Benjamin I. Vaught, Seattle, WA (US); Alex Aben-Athar Kipman, Redmond, WA (US); Georg Klein, Seattle, WA (US); Frederik Schaffalitzky, Bellevue, WA (US); David Nister, Bellevue, WA (US); Russ McMackin, Kirkland, WA (US); Doug Barnes, Kirkland, WA (US)

(72) Inventors: Jeffrey N. Margolis, Seattle, WA (US); Benjamin I. Vaught, Seattle, WA (US); Alex Aben-Athar Kipman, Redmond, WA (US); Georg Klein, Seattle, WA (US); Frederik Schaffalitzky, Bellevue, WA (US); David Nister, Bellevue, WA (US); Russ McMackin, Kirkland, WA (US); Doug Barnes, Kirkland, WA (US)

(21) Appl. No.: 13/713,910

(22) Filed: Dec. 13, 2012

(51) Int. Cl. G06T 19/00

(52) U.S. Cl. CPC G06T 19/006
USPC 345/633

(57) ABSTRACT

A system and method are disclosed for interacting with virtual objects in a virtual environment using an accessory such as a hand held object. The virtual object may be viewed using a display device. The display device and hand held object may cooperate to determine a scene map of the virtual environment, the display device and hand held object being registered in the scene map.

### BACKGROUND

Mixed reality is a technology that allows virtual imagery to be mixed with a real-world physical environment. A see-through, head mounted, mixed reality display device may be worn by a user to view the mixed imagery of real objects and virtual objects displayed in the user's field of view. The head mounted display device is able to create a three-dimensional map of the surroundings within which virtual and real objects may be seen. Users are able to interact with virtual objects by selecting them, for example by looking at virtual object. Once selected, a user may thereafter manipulate or move the virtual object, for example by grabbing and moving it or performing some other predefined gesture with respect to the object.

This type of indirect interaction has disadvantages. For example, the position of a user's hand is estimated within the scene map created by the head mounted display device, and the estimated position may drift over time. This can result in a grasped virtual object being displayed outside of a user's hand. It may also at times be counterintuitive to select objects using head motions.

### SUMMARY

Embodiments of the present technology relate to a system and method for interacting with three-dimensional virtual objects within a virtual environment. A system for creating virtual objects within a virtual environment may include in part a see-through, head mounted display device coupled to one or more processing units. The processing units in cooperation with the head mounted display unit(s) are able to define a scene map of virtual objects within the virtual environment.

The system may further include an accessory such as a hand held device which moves independently of the head mounted display device. In embodiments, the hand held device may cooperate with the head mounted display device and/or processing unit(s) so that the hand held device may be registered in the same scene map used by the head mounted display device.

The hand held object may include a camera affixed to a puck. The puck may have an input pad including for example a capacitive touch screen enabling a user to select commands on the input pad for interacting with a virtual object displayed by the head mounted display device. The camera may discern points in its field of view in common with points discerned by one or more image capture devices on the head mounted display device. These common points may be used to resolve the positions of the head mounted display device relative to the hand held device, and register both devices in the same scene map. The registration of the hand held device in the scene map of the head mounted display device allows direct interaction of the hand held device with virtual objects displayed by the head mounted display device.

In an example, the present technology relates to a system for presenting a virtual environment, the virtual environment being coextensive with a real-world space, the system comprising: a display device at least in part assisting in the determination of a scene map including one or more virtual objects, the display device including a display unit for displaying a virtual object of the one or more virtual objects in the virtual environment; and an accessory capable of being moved in the real-world space independently of the display device, the accessory registered within the same scene map as the display device.

In another example, the present technology relates to a system for presenting a virtual environment, the virtual environment being coextensive with a real-world space, the system comprising: a display device at least in part assisting in the determination of a scene map including one or more virtual objects, the display device including a display unit for displaying a virtual object of the one or more virtual objects in the virtual environment; and an accessory registered within the same scene map as the display device, the accessory capable of interacting with the virtual object.

In a further example, the present technology relates to a method of direct interaction with virtual objects within a virtual environment, the virtual environment being coextensive with a real-world space, the method comprising: (a) defining a scene map for the virtual environment, a position of a virtual object being defined within the scene map; (b) displaying the virtual object via a display device, a position of the display device being registered within the scene map; and (c) directly interacting with the virtual object displayed by the display device using a hand held device, a position of the hand held device being registered within the scene map.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a virtual environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a capture device of the head mounted display unit and a processing unit.

FIG. 6 is a block diagram of one embodiment of the components of a processing unit associated with a head mounted display unit.

FIG. 7 is a perspective view of a hand held device according to embodiments of the present disclosure.

FIG. 8 is a block diagram of a puck provided as part of a hand held device according to embodiments of the present disclosure.

FIG. 9 is an illustration of an example of a virtual environment with a user interacting with a virtual object using a hand held device.

FIG. 10 is a flowchart showing the operation and collaboration of the one or more processing units, a head mounted display device and a hand held device of the present system.

FIG. 11 is a more detailed flowchart of step 608 of the flowchart of FIG. 10.

### DETAILED DESCRIPTION

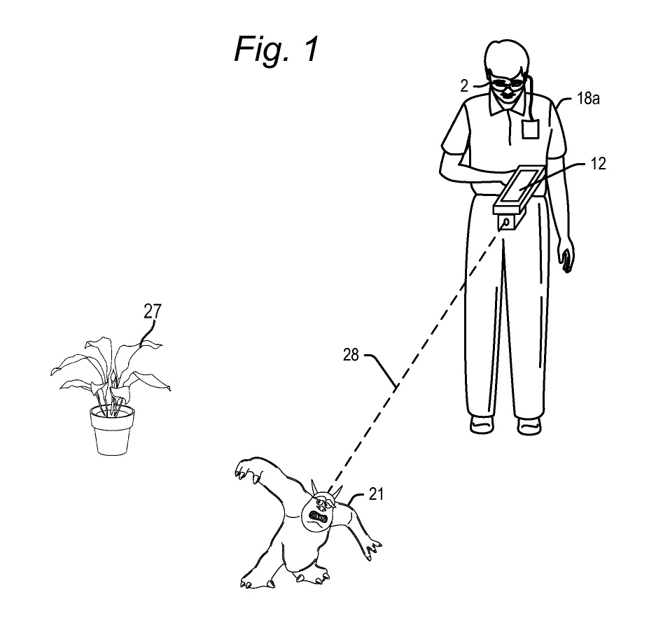

Embodiments of the present technology will now be described with reference to FIGS. 1-11, which in general relate to a system and method for directly interacting with virtual objects in a mixed reality environment. In embodiments, the system and method may use a hand-held device capable of tracking and registering itself in a three-dimensional scene map generated by a head mounted display device. The hand-held device and/or the head mounted display device may include a mobile processing unit coupled to or integrated within the respective devices, as well as a camera for capturing a field of view around a user.

Each user may wear a head mounted display device including a display element. The display element is to a degree transparent so that a user can look through the display element at real-world objects within the user's field of view (FOV). The display element also provides the ability to project virtual images into the FOV of the user such that the virtual images may also appear alongside the real-world objects. The system automatically tracks where the user is looking so that the system can determine where to insert the virtual image in the FOV of the user. Once the system knows where to project the virtual image, the image is projected using the display element.

In embodiments, the head mounted display device and/or the hand held device may cooperate to build a model of the environment including six degrees of freedom the x, y, z, pitch, yaw and roll positions of users, real-world objects and virtual three-dimensional objects in the room or other environment. The positions of each head mounted display device worn by the users in the environment may be calibrated to the model of the environment and to each other. This allows the system to determine each user's line of sight and FOV of the environment. Thus, a virtual image may be displayed to each user, but the system determines the display of the virtual image from each user's perspective, adjusting the virtual image for parallax and any occlusions from or by other objects in the environment. The model of the environment, referred to herein as a scene map, as well as tracking of each user's FOV and objects in the environment may be generated by one or more processing unit working in tandem or individually.

In accordance with aspects of the present technology, the hand held device may also be calibrated to and registered within the model of the environment. As explained hereinafter, this allows the position and movement (translation and rotation) of the hand held device to be accurately known within the model of the environment, also referred to as a scene map.

A virtual environment provided by present system may be coextensive with a real-world space. In other words, the virtual environment may be laid over and share the same area as a real-world space. The virtual environment may fit within the confines of a room or other real-world space. Alternatively, the virtual environment may be larger than the confines of the real-world physical space.

A user moving around a real-world space may also move around in the coextensive virtual environment, and view virtual and/or real objects from different perspectives and vantage points. One type of virtual environment is a mixed reality environment, where the virtual environment includes both virtual objects and real-world objects. Another type of virtual environment includes just virtual objects.

As explained below, the hand held object may be used to select and directly interact with virtual objects within a virtual environment. However, a user may interact with virtual objects using the hand held object in combination with other physical and/or verbal gestures. Therefore, in addition to actuation of buttons and/or a touch screen on the hand held device, physical gestures may further include performing a predefined gesture using fingers, hands and/or other body parts recognized by the mixed reality system as a user request for the system to perform a predefined action. Physical interaction may further include contact by the hand held device or other parts of the user with a virtual object. For example, a user may place the hand held object in contact with or within a virtual object, and thereafter pushing or bumping the virtual object.

A user may alternatively or additionally interact with virtual objects using the hand held device together with verbal gestures, such as for example a spoken word or phrase recognized by the mixed reality system as a user request for the system to perform a predefined action. Verbal gestures may be used in conjunction with physical gestures to interact with one or more virtual objects in the virtual environment.

FIG. 1 illustrates a system 10 for providing a mixed reality experience by fusing virtual content 21 with real content 27 within a user's FOV. FIG. 1 shows a user 18 wearing a head mounted display device 2, which in one embodiment is in the shape of glasses so that the user can see through a display and thereby have an actual direct view of the space in front of the user. The use of the term “actual direct view” refers to the ability to see the real-world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

Aspects of the present technology may further include a hand held device 12, which may be carried by a user. While called a hand held device in embodiments and shown as such in FIG. 1, the device 12 may more broadly be referred to as an accessory which may be moved independently of the head mounted display device and registered within the scene map of the head mounted display device. The accessory may be manipulated while not held in a user's hand. It may be strapped to a user's arm or leg, or may be positioned on a real object within the environment.

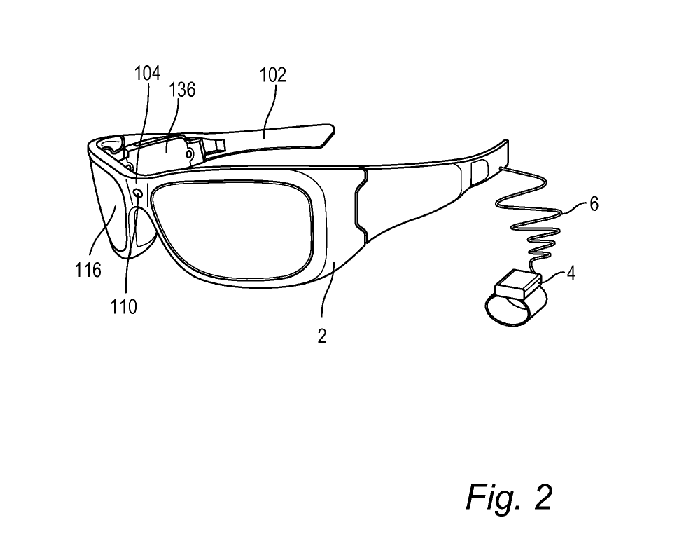

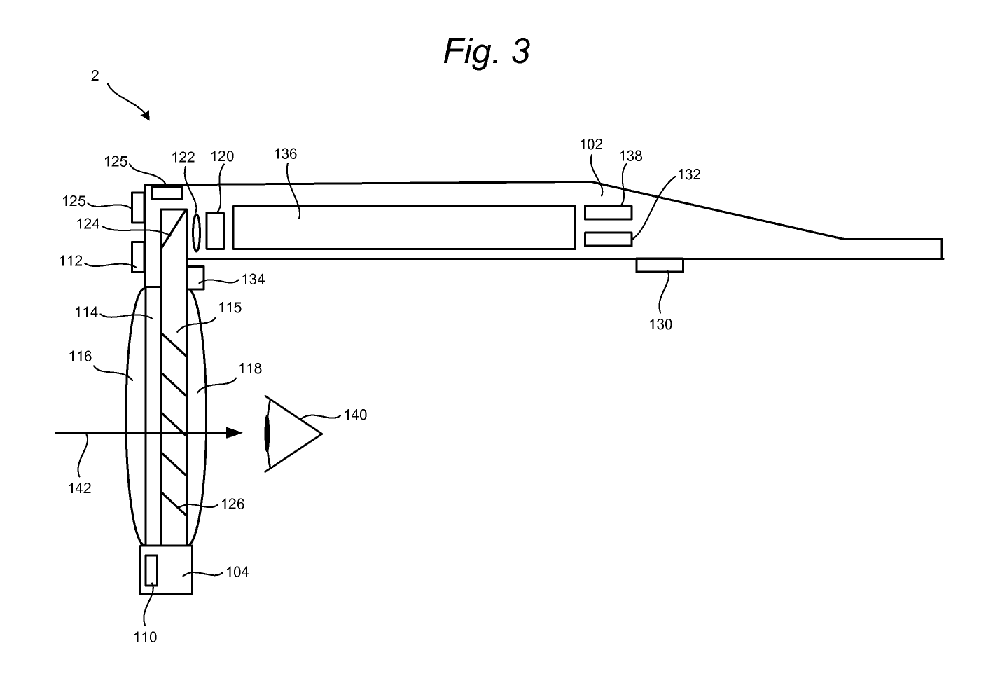

As seen in FIGS. 2 and 3, each head mounted display device 2 is in communication with its own processing unit 4 via wire 6. In other embodiments, head mounted display device 2 communicates with processing unit 4 via wireless communication. In one embodiment, processing unit 4 is a small, portable device for example worn on the user's wrist or stored within a user's pocket. The processing unit may for example be the size and form factor of a cellular telephone, though it may be other shapes and sizes in further examples. In a further embodiment, processing unit 4 may be integrated into the head mounted display device 4. The processing unit 4 may include much of the computing power used to operate head mounted display device 2. In embodiments, the processing unit 4 communicates wirelessly (e.g., WiFi, Bluetooth, infra-red, or other wireless communication means) with the hand held device 12. In further embodiments, it is contemplated that the processing unit 4 instead be integrated into the hand held device 12.

FIGS. 2 and 3 show perspective and side views of the head mounted display device 2. FIG. 3 shows the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 are one or more room-facing capture devices 125 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. In some embodiments, head mounted display device 2 may include one see-through lens or no see-through lenses. In another alternative, a prescription lens can go inside light-guide optical element 115. Opacity filter 114 filters out natural light (either on a per pixel basis or uniformly) to enhance the contrast of the virtual imagery. Light-guide optical element 115 channels artificial light to the eye.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens.

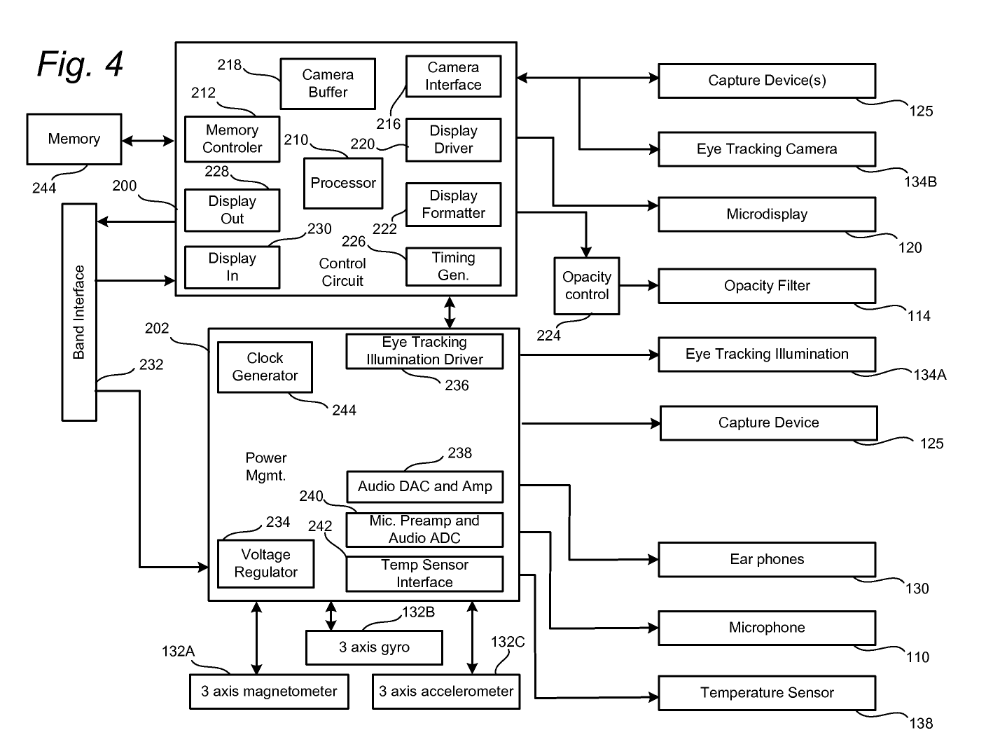

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008, incorporated herein by reference in its entirety. It is understood that light-guide optical element 115 may operate by projection optics instead of or in addition to reflection through waveguides. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an example of opacity filter 114 are provided in U.S. Patent Publication No. 2012/0068913 to Bar-Zeev et al., entitled “Opacity Filter For See-Through Mounted Display,” filed on Sep. 21, 2010, incorporated herein by reference in its entirety. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel.

A mask of alpha values can be used from a rendering pipeline, after z-buffering with proxies for real-world objects. When the system renders a scene for the augmented reality display, it takes note of which real-world objects are in front of which virtual objects as explained below. If a virtual object is in front of a real-world object, then the opacity may be on for the coverage area of the virtual object. If the virtual object is (virtually) behind a real-world object, then the opacity may be off, as well as any color for that pixel, so the user will see the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008, incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 shows half of the head mounted display device 2. A full head mounted display device may include another set of see-through lenses, another opacity filter, another light-guide optical element, another microdisplay 120, another lens 122, room-facing camera, eye tracking assembly, micro display, earphones, and temperature sensor.

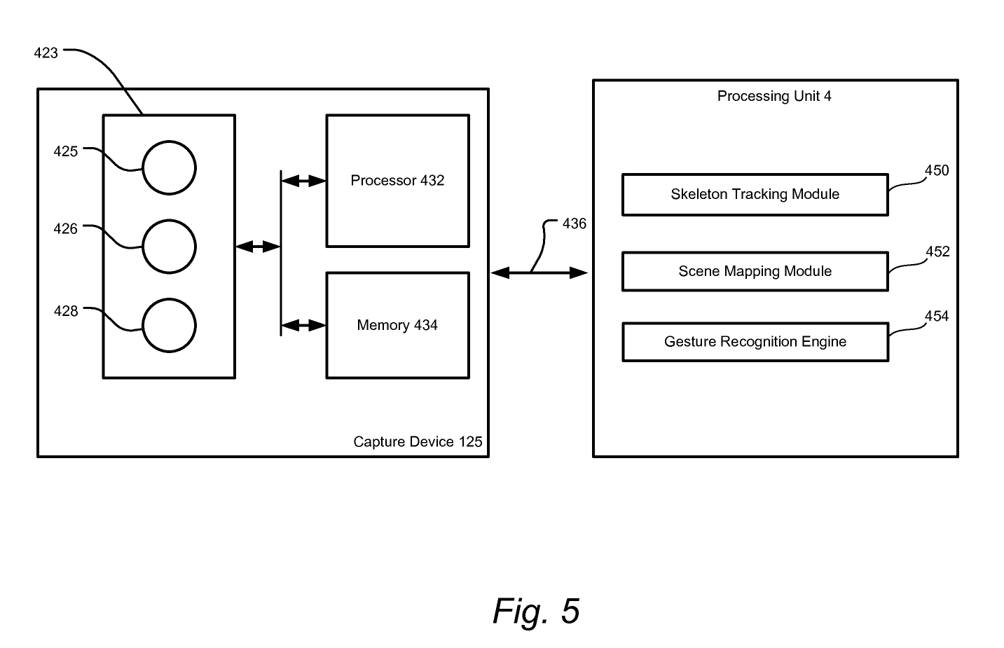

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2. Based on that information and data, processing unit 4 will determine where and when to provide a virtual image to the user and send instructions accordingly to the head mounted display device of FIG. 4.

FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, the components of control circuit 200 are in communication with each other via dedicated lines or one or more buses. In another embodiment, the components of control circuit 200 is in communication with processor 210. Camera interface 216 provides an interface to image capture devices 125 and stores images received from the image capture devices in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from image capture devices 125 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

Head mounted display 2 may further include a plurality of capture devices 125, for capturing RGB and depth images of the FOV of the user to enable construction of a scene map and three dimensional model of the user's environment. FIG. 3 shows two such capture devices 125 schematically, one facing a front of the head mounted display 2, and the other facing to the side. The opposite side may include the same configuration to provide four capture devices 125 to view a scene from different angles to obtain visual stereo data that may be resolved to generate depth information. There may be more or less capture devices in further embodiments.

According to an example embodiment, capture device 125 may be configured to capture video with depth information including a depth image that may include depth values via any suitable technique including, for example, time-of-flight, structured light, stereo image, or the like. According to one embodiment, the capture device 125 may organize the depth information into “Z layers,” or layers that may be perpendicular to a Z axis extending from the depth camera along its line of sight.

A schematic representation of capture device 125 is shown in FIG. 5. Capture device 125 may have camera component 423 which in embodiments may be or include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 125 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. In further embodiments, the 3-D camera and RGB camera may exist on the same sensor, for example utilizing advanced color filter patterns. In some embodiments, pulsed infrared light may be used such that the time between an outgoing light pulse and a corresponding incoming light pulse may be measured and used to determine a physical distance from the capture device 125 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 125 to a particular location on the targets or objects by analyzing the intensity of the reflected beam of light over time via various techniques including, for example, shuttered light pulse imaging.

In another example embodiment, capture device 125 may use a structured light to capture depth information. In such an analysis, patterned light (i.e., light displayed as a known pattern such as a grid pattern, a stripe pattern, or different pattern) may be projected onto the scene via, for example, the IR light component 425. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR light component 425 is displaced from the cameras 426 and 428 so triangulation can be used to determined distance from cameras 426 and 428. In some implementations, the capture device 125 will include a dedicated IR sensor to sense the IR light, or a sensor with an IR filter.

In an example embodiment, the capture device 125 may further include a processor 432 that may be in communication with the camera component 423. Processor 432 may include a standardized processor, a specialized processor, a microprocessor, or the like that may execute instructions including, for example, instructions for receiving a depth image, generating the appropriate data format (e.g., frame) and transmitting the data to processing unit 4.

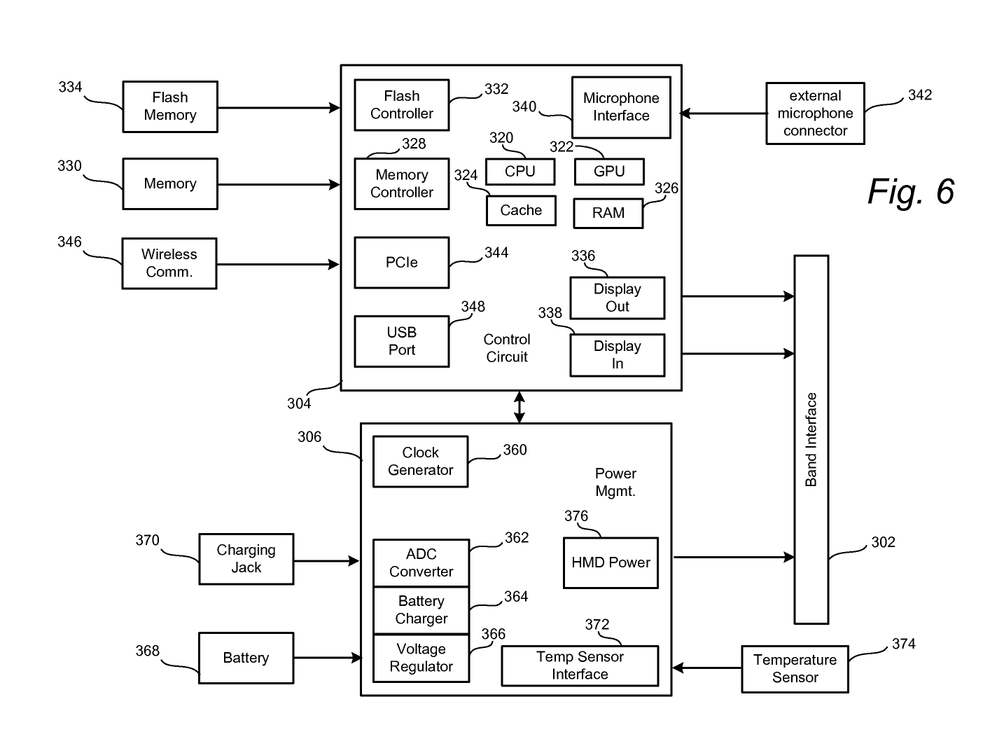

Capture device 125 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. In further embodiments, the processor 432 and/or memory 434 may be integrated into the control circuit of the head mounted display device 2 (FIG. 4) or the control circuit of the processing unit 4 (FIG. 6).

Capture device 125 may be in communication with processing unit 4 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, processing unit 4 may provide a clock (such as clock generator 360, FIG. 6) to capture device 125 that may be used to determine when to capture, for example, a scene via the communication link 436. Additionally, the capture device 125 provides the depth information and visual (e.g., RGB) images captured by, for example, the 3-D camera 426 and/or the RGB camera 428 to processing unit 4 via the communication link 436. In one embodiment, the depth images and visual images are transmitted at 30 frames per second; however, other frame rates can be used. Processing unit 4 may then create and use a model, depth information, and captured images to, for example, control an application which may include the generation of virtual objects.

Processing unit 4 may include a skeletal tracking module 450. Module 450 uses the depth images obtained in each frame from capture device 125, and possibly from cameras on the one or more head mounted display devices 2, to develop a representative model of user 18 (or others) within the FOV of capture device 125 as each user moves around in the scene. This representative model may be a skeletal model described below. Processing unit 4 may further include a scene mapping module 452. Scene mapping module 452 uses depth and possibly RGB image data obtained from capture device 125 to develop a map or model of the scene in which the user 18 exists. The scene map may further include the positions of the users obtained from the skeletal tracking module 450. The processing unit 4 may further include a gesture recognition engine 454 for receiving skeletal model data for one or more users in the scene and determining whether the user is performing a predefined gesture or application-control movement affecting an application running on processing unit 4.

More information about gesture recognition engine 454 can be found in U.S. patent application Ser. No. 12/422,661, entitled “Gesture Recognizer System Architecture,” filed on Apr. 13, 2009, incorporated herein by reference in its entirety. Additional information about recognizing gestures can also be found in U.S. patent application Ser. No. 12/391,150, entitled “Standard Gestures,” filed on Feb. 23, 2009; and U.S. patent application Ser. No. 12/474,655, entitled “Gesture Tool” filed on May 29, 2009, both of which are incorporated herein by reference in their entirety.

Capture device 125 provides RGB images (or visual images in other formats or color spaces) and depth images to processing unit 4. The depth image may be a plurality of observed pixels where each observed pixel has an observed depth value. For example, the depth image may include a two-dimensional (2-D) pixel area of the captured scene where each pixel in the 2-D pixel area may have a depth value such as the distance of an object in the captured scene from the capture device. Processing unit 4 will use the RGB images and depth images to develop a skeletal model of a user and to track a user's or other object's movements. There are many methods that can be used to model and track the skeleton of a person with depth images. One suitable example of tracking a skeleton using depth image is provided in U.S. patent application Ser. No. 12/603,437, entitled “Pose Tracking Pipeline” filed on Oct. 21, 2009, (hereinafter referred to as the '437 application), incorporated herein by reference in its entirety.

The process of the '437 application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a group of joints and connections between the joints. Other methods for user modeling and tracking can also be used. Suitable tracking technologies are also disclosed in the following four U.S. patent applications, all of which are incorporated herein by reference in their entirety: U.S. patent application Ser. No. 12/475,308, entitled “Device for Identifying and Tracking Multiple Humans Over Time,” filed on May 29, 2009; U.S. patent application Ser. No. 12/696,282, entitled “Visual Based Identity Tracking,” filed on Jan. 29, 2010; U.S. patent application Ser. No. 12/641,788, entitled “Motion Detection Using Depth Images,” filed on Dec. 18, 2009; and U.S. patent application Ser. No. 12/575,388, entitled “Human Tracking System,” filed on Oct. 7, 2009.

FIG. 6 is a block diagram describing the various components of processing unit 4. FIG. 6 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to a computing device (not shown) in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

The above-described head mounted display device 2 and processing unit 4 are able to insert a virtual three-dimensional object into the FOV of one or more users so that the virtual three-dimensional object augments and/or replaces the view of the real world. As noted, the processing unit 4 may be partially or wholly integrated into the head mounted display 2, so that the above-described computation for generating a depth map for a scene is performed within the head mounted display 2. In further embodiments, some or all of the above-described computation for generating a depth map for a scene may alternatively or additionally be performed within the hand held device 12.

In one example embodiment, the head mounted display 2 and processing units 4 work together to create the scene map or model of the environment that the one or more users are in and track various moving objects in that environment. In addition, the head mounted display 2 and processing unit 4 may track the FOV of a head mounted display device 2 worn by a user 18 by tracking the position and orientation of the head mounted display device 2. Sensor information obtained by head mounted display device 2 is transmitted to processing unit 4, which in one embodiment may then update the scene model. The processing unit 4 then uses additional sensor information it receives from head mounted display device 2 to refine the FOV of the user and provide instructions to head mounted display device 2 on where, when and how to insert the virtual three-dimensional object. Based on sensor information from cameras in the capture device 125, the scene model and the tracking information may be periodically updated between the head mounted display 2 and processing unit 4 in a closed loop feedback system as explained below.

Referring to FIGS. 1 and 7-9, the present disclosure further includes hand held device 12, which may be used to directly interact with virtual objects projected into a scene. The hand held device 12 may be registered within the scene map generated by head mounted display device 2 and processing unit 4 as explained below so that the position and movement (translation and/or rotation) of the hand held device 12 may be updated each frame. This allows for direct interaction of the hand held device 12 with virtual objects within a scene. “Direct” versus “indirect” as used herein refers to the fact that a position of unregistered objects in a scene, such as a user's hand, is estimated based on the depth data captured and the skeletal tracking software used to identify body parts. At times, when tracking hands or other body parts, it may be difficult to derive an accurate orientation or to reliably fit an accurate hand model to the depth map. As such, there is no “direct” knowledge of a position of unregistered objects such as a user's hand. When a user interacts with virtual objects using a hand, this interaction is said to be indirect, based on the above estimation of hand position.

By contrast, as the position of the hand held device is registered within the same scene map generated by the head mounted display device 2 and processing unit 4 (the device 2 and unit 4 may at times collectively be referred to herein as the mobile display device). As explained below, in one example, the hand held device 12 includes a camera which is capable of identifying points which may be equated to the same points in the scene map devised by the mobile display device. Once those common points are identified, various methodologies may be used to identify and register the position of the hand held device 12 within the scene map of the mobile display device.

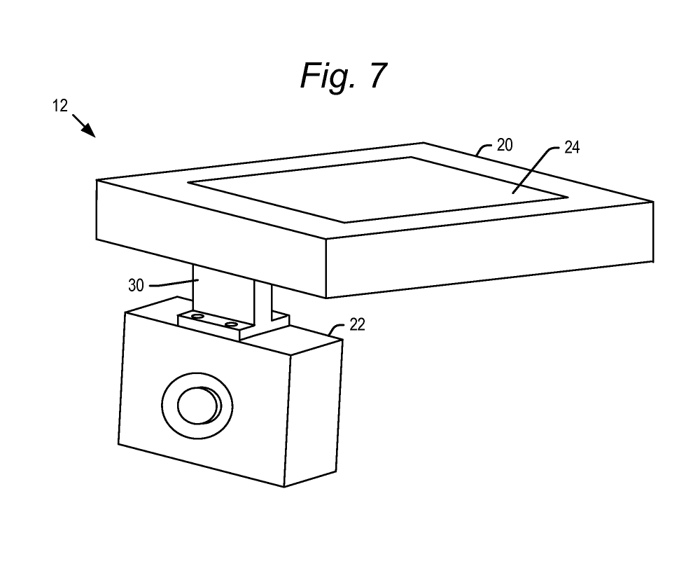

FIG. 7 shows a perspective view of a hand held device 12. Device 12 may in general include a puck 20 fixedly mounted to or integrally formed with an image capture device 22. Puck 20 may serve a number of functions. One such function is an input/feedback device allowing a user to control interactions with virtual objects in a scene. In particular, puck 20 may include an input pad 24 for receiving user input. In one example, input pad 24 may include a capacitive or other touch-sensitive screen. In such examples, the input pad 24 may display one or more screens which display graphical buttons, wheels, slides or other controls, each associated with predefined commands for facilitating interaction with a virtual object. As is known, a given command in such an example may be generated by the user contact with the screen to actuate the graphical button, wheel, slide, etc. In further embodiments, instead of a touch-sensitive screen, the input pad may be formed of actual buttons, wheels, slides or other controls which may be actuated to effect a command as described above.

As one of many possible examples, a user may actuate a control on input pad 24 to extend a ray out from the hand held device 12, as shown in FIG. 1. Upon actuation of the appropriate control, a virtual ray 28 may be generated and displayed to the user via the mobile display device, extending from a front of the hand held device 12. The use of ray 28 is explained below. As another example, a user may actuate a control on input pad 24 to grasp a virtual object. In such an example, the system detects contact of the hand held device 12 on a surface of, or within, a virtual object, and thereafter may tie a position of the virtual object to the hand held device 12. A user may thereafter release the virtual object by releasing the control, or actuation of another control on input pad 24. Further buttons, wheels and slides may be used to perform a variety of other commands, including for example:
push virtual objects away from hand held device 12,
pull virtual objects closer to hand held device 12,
move virtual objects back, forward, left, right, up or down,
resize virtual objects,
rotate virtual objects,
copy and/or paste virtual objects,
remove virtual objects,
change a color, texture or shape of virtual objects,
animate objects to move around within the virtual environment in a user-defined manner.
   Other commands are contemplated. These interactions may be initiated by selection of an appropriate command on input pad 24. In further embodiments, these interactions may be initiated by a combination of selecting commands on input pad 24 and performance of some other predefined gesture (physical and/or verbal). In further embodiments, at least some of the above-described interactions may be performed by performance of physical gestures unrelated to the input pad 24.

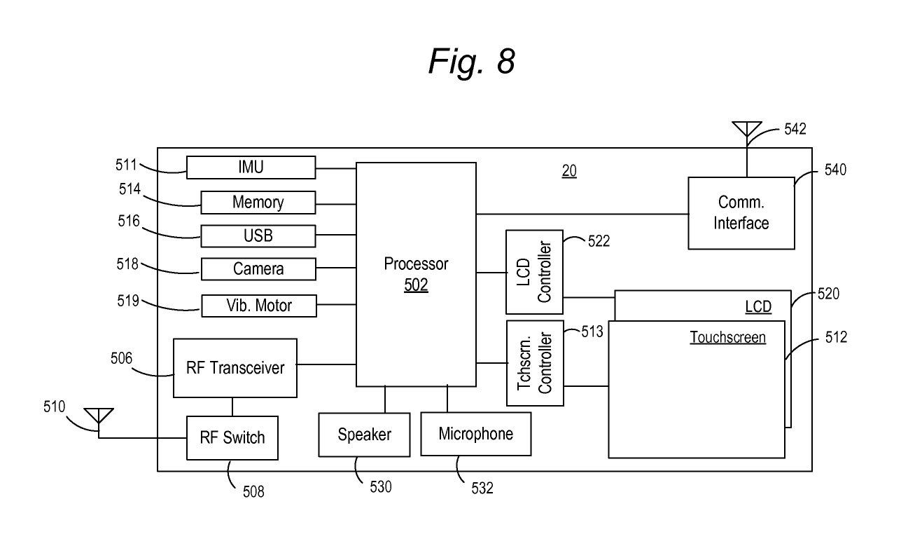

Puck 20 may further provide feedback to the user. This feedback may be visually displayed to the user via input pad 24, and/or audibly played to the user, via speakers provided on puck 20. In further embodiments, puck 20 may be provided with a vibratory motor 519 (FIG. 8) providing a haptic response to the user. In embodiments, hand held device may be used, at least at times, so that the user is looking at the scene and not at the hand held device. Thus, where a user is selecting an object as explained below, the puck 20 may provide a haptic response indicating when the user has locked onto an object, or successfully performed some other intended action.

Another function of puck 20 is to provide angular and/or translational acceleration and position information of the hand held device 12. Puck 20 may include an IMU 511 (FIG. 8) which may be similar or identical to IMU 132 in the head mounted display unit. Such an IMU may for example include inertial sensors such as a three axis magnetometer, three axis gyro and three axis accelerometer to sense position, orientation, and accelerations (pitch, roll and yaw) of the hand held device 12. As noted above and explained below, the x, y and z position and orientation of the hand held device 12 is registered in the scene map through cooperation of the hand held device 12 and mobile display device. However, data provided by the IMU within the hand held device 12 may confirm and/or supplement the position and/or orientation of the hand held device in the scene map of the mobile display device. In further embodiments, it is contemplated that the IMU in the hand held device 12 may be omitted.

FIG. 8 shows a block diagram of one example of some of the hardware components internal to puck 20. In one example, puck 20 may be a conventional cellular telephone. In such embodiments, puck 20 may have a conventional hardware configuration for cellular telephones, and may operate to perform the functions conventionally known for cellular telephones. Additionally, a software application program and other software components may be loaded onto puck 20 to allow the telephone to operate in accordance the present technology. In further embodiments, the puck 20 may be a dedicated hardware device customized for operation with the present technology.

Puck 20 may include a processor 502 for controlling operation of puck 20 and interaction with the mobile display device. As noted above, one function of puck 20 is to provide acceleration and positional information regarding puck 20. This information may be provided to processor 502 via IMU 511. Puck 20 may further include memory 514, for storing software code executed by processor 503, and data such as acceleration and positional data, image data and a scene map.

Puck 20 may further include a user interface including LCD screen 520 and touchscreen 512, which together act as input pad 24 described above. LCD screen 520 and touchscreen 512 may communicate with processor 502 via LCD controller 522 and touchscreen controller 513, respectively. Touchscreen 512 may be a capacitive surface laid over LCD screen 520. However, as noted above, touchscreen 512 may be replaced by any of a variety of physical actuators alongside LCD screen 520 in further embodiments. Where a conventional telephone, at least some of the physical actuators may be assigned functions for controlling user input as described above.

Puck 20 may further include a connection 516 for connecting puck 20 to another device, such as for example a computing device (not shown). Connection 516 may be a USB connection, but it is understood that other types of connections may be provided, including serial, parallel, SCSI and an IEEE 1394 (“Firewire”) connections.

Puck 20 may further include a camera 518 as is known in the art. Camera 518 may have some, all and/or additional components to those described below with respect to camera 22. In embodiments, the puck 20 may display an FOV captured by camera 518 or camera 22.

As noted above, puck 20 may include various feedback components including a vibratory motor 519 capable of providing haptic feedback, and a speaker 530 for providing audio. A microphone 532 of known construction may further be provided for receiving voice commands.

Puck 20 may further include components enabling communication between puck 20 and other components such as the mobile display device. These components include a communication interface 540 capable of wireless communication with the mobile display device via wireless communication device 346 of the processing unit 4, via an antenna 542. Puck 20 may be hardwired to camera 22 as described below, but it may be wirelessly connected and communicate via communication interface 540 in further embodiments.

Moreover, communications interface 540 may send and receive transmissions to/from components other than the mobile display device and camera 22 in embodiments of the technology. For example, the puck 20 may communicate with a host computer to transfer data, such as photographic and video images, as well as software such as application programs, APIs, updates, patches, etc. Communications interface 540 may also be used to communicate with other devices, such as hand-held computing devices including hand-held computers, PDAs and other mobile devices according to embodiments of the technology. Communications interface 540 may be used to connect puck 20, and camera 22 to a variety of networks, including local area networks (LANs), wide area networks (WANs) and the Internet.

Although not critical, puck 20 may further a digital baseband and/or an analog baseband for handling received digital and analog signals. RF Transceiver 506 and switch 508 may be provided for receiving and transmitting analog signals, such as an analog voice signal, via an antenna 510. In embodiments, transceiver 504 may perform the quadrature modulation and demodulation, as well as up- and down-conversion from dual-band (800 and 1900 MHz) RF to baseband. The various communication interfaces described herein may include a transceiver and/or switch as in transceiver 506 and switch 508.

It is understood that puck 20 may have a variety of other configurations and additional or alternative components in alternative embodiments of the technology.

Referring again to FIG. 7, camera 22 may in embodiments be a device similar to capture device 125, so that the above description of capture device 125 similarly applies to camera 22. In further embodiments, camera 22 may instead simply be standard off the shelf camera capable of capturing still image and video images.

The camera 22 may be affixed beneath the puck 20 as shown, though the camera 22 may be affixed in front, on the side or even behind the puck 20 in further embodiments. The camera 22 may be affixed to puck 20 via a bracket 30 and fasteners, though the camera 22 may be integrally formed with the puck 20 in further embodiments. In the example shown, the camera is front facing. This provides the advantage that the camera may capture the FOV in front of the user, while the input pad 24 is facing up to the user for ease of viewing the input pad 24. However, in further embodiments, the camera may face upward so that the camera lens is generally parallel to a surface of the input pad 24. In further embodiments, the camera lens may be at some oblique angle to the surface of the input pad. It is further contemplated that camera 22 may be omitted, and the camera 518 within the puck 20 perform the functionality of camera 22.

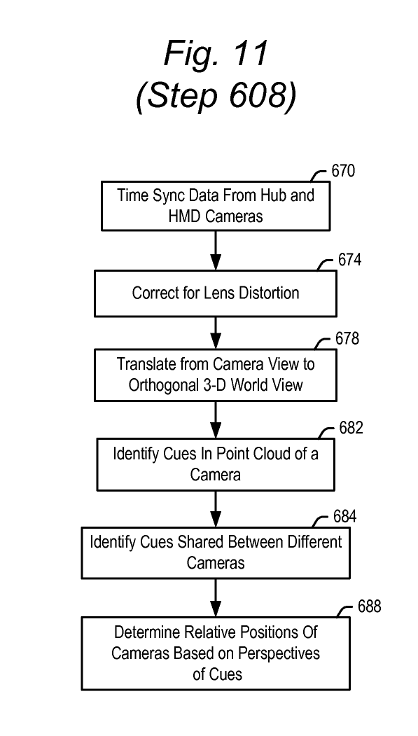

As noted above, the hand held device 12 and the mobile display may cooperate to register a precise position of the hand held device 12 in the x, y, z scene map of the FOV determined by the mobile display device as described above. One method for registration is described below with respect to the flowchart of FIG. 11. However other registration methods are possible.

While a particular configuration of puck 20 is shown in FIG. 7, it is understood that puck 20 may assume a variety of different configurations and provide the above-described functionality. In a further embodiment, the camera 22 may be omitted, and all tracking function be performed by the IMU 511 provided within the puck 20.

Using the components described above, users may directly interact with virtual objects in a virtual environment using the hand held device 12 which is registered within the same scene map used by the mobile display device which generates the virtual images. One example is shown in FIG. 1. A user may indicate a desire to select an object using the hand held device 12 by extending a ray from the device 12. Upon selecting the appropriate command on the input pad 24 of puck 20, the mobile display device displays a virtual ray 28 which extends from a portion of the hand held device 12 (such as out of the front). It is understood that the ray 28 may appear by the user performing a gesture other than interaction with input pad 24. As the system 10, comprised of the mobile display device and the hand held device, knows the precise position and orientation of the hand held device, the ray 28 may be displayed as emanating from a fixed point on the hand held device 12 as the device 12 is rotated or moves around. Moreover, as the device 12 is rotated or moves around, the ray moves in a one to one relation with the device 12.

A user may point at a real or virtual object using ray 28, and the ray 28 may extend until it intersects with a real or virtual object. A user may directly interact with a virtual object by pointing the ray 28 at it. Once the ray intersects with a virtual object, such as virtual object 21 in FIG. 1, feedback may be provided to the user to indicate selection of that virtual object. As noted above, the feedback may be visual, audible and/or haptic. In embodiments, the user may need to keep the ray 28 trained on a virtual object for some predetermined period of time before the object is considered selected to prevent spurious selection of objects. It may be that a user wishes to select an object that is obscured by another object (real or virtual), with the mobility of the present system, the user may move around in the environment until there is a clear line of sight to the desired object, at which point the user may select the object.

Once selected, a user may interact with an object in any number of ways. The user may move the virtual object closer or farther along the ray. The use may additionally or alternatively reposition the ray, with the object affixed thereto, and place the virtual object in precisely the desired location. Additional potential interactions are described above.

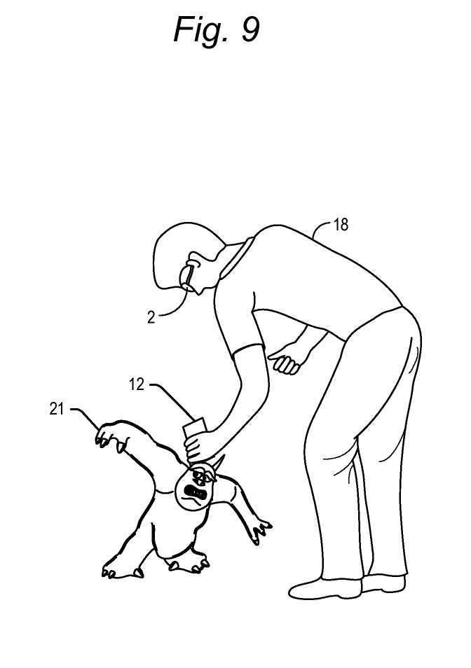

FIG. 1 illustrates an interaction where a virtual object 21 is selected via a virtual ray which extends from the hand held device 12 upon the user selecting the appropriate command on the input pad 24. In further embodiments, shown for example in FIG. 9, a user may interact with a virtual object by physically contacting the object with the hand held device 12. In such embodiments, a user may place a portion of the hand held device 12 in contact with a surface of a virtual object 21, or within an interior of a virtual object 21 to select it. Thereafter, the use may select a control on input pad 24 or perform a physical gesture to interact with the virtual object 21. As noted above, this interaction may be any of a variety of interactions, such as carrying the object to a new position and setting it down, replicating the object, removing the object, etc.

Instead of grasping an object upon user contact, the object may instead “bounce” away as a result of a collision with the object. The reaction of an object to the collision may be defined by physics and may be precise. That is, as the velocity of the hand held device 12 upon collision may be precisely known from IMU and other data, the virtual object may bounce away with a precise velocity. This velocity may be determined by physics and a set of deformation and elasticity characteristics defined for the virtual object.

As explained below, the positions of virtual objects in the scene map are known by, for example, the processing unit 4. By registering the hand held device 12 within the same scene map, the user is able to directly interact with virtual objects within the scene map, or create new virtual objects in the scene map, which are then displayed via the head mounted display device 12. Such direct interaction allows interaction and/or creation of virtual objects at precise locations in the virtual environment and in precise ways.

Moreover, the present system operates in a non-instrumented environment. That is, some prior art systems uses a ring or other configuration of fixed image capture devices to determine positions of objects within the FOV of the image capture devices. However, as both the mobile display device and hand held device 12 may move with the user, the present technology may operate in any environment in which the user moves. It is not necessary to set up the environment beforehand.

While a particular configuration of puck 20 is shown in FIG. 7, it is understood that puck 20 may assume a variety of different configurations and provide the above-described functionality. In one further embodiment, the puck 20 may be configured as a gun, or some other object which shoots, for use in a gaming application where virtual objects are targeted. As the position and orientation of the hand held device 12 are precisely known and registered within the frame of reference of the mobile display unit displaying the virtual targets, accurate shooting reproductions may be provided. The puck 20 may be used in other applications in further embodiments.

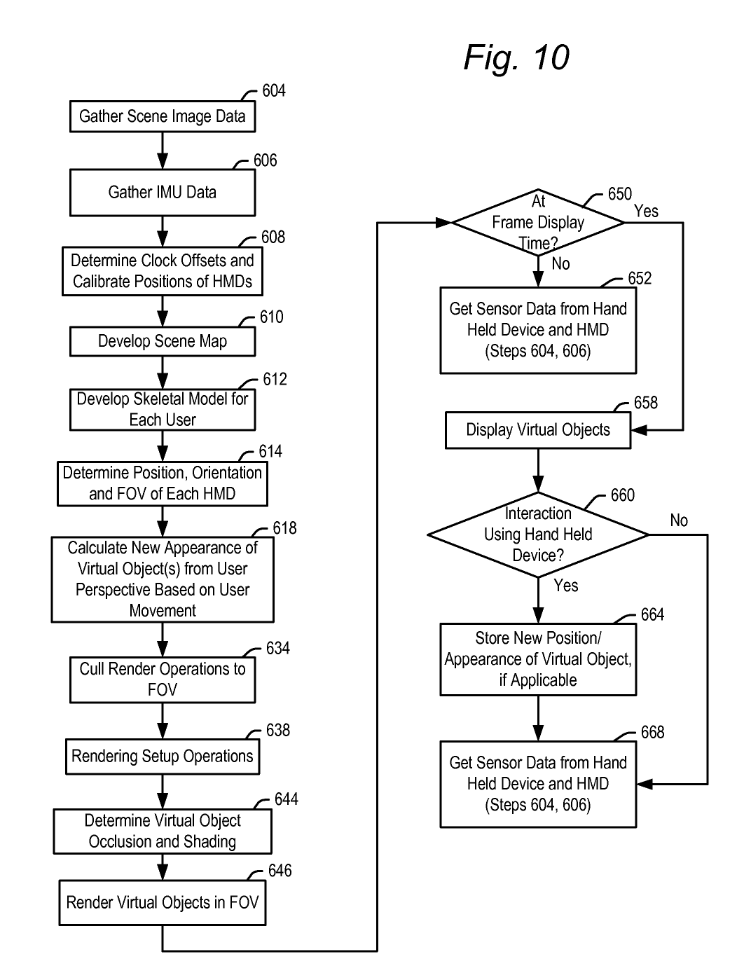

FIG. 10 is high level flowchart of the operation and interactivity of the processing unit 4, head mounted display device 2 and hand held device 12 during a discrete time period such as the time it takes to generate, render and display a single frame of image data to each user. In embodiments, the processes taking place in the processing unit 4, head mounted display device 2 and hand held device 12 may take place in parallel, though the steps may take place serially in further embodiments. Moreover, while the steps within each component are shown taking place step-by-step serially, one or more of the steps within a component may take place in parallel with each other. For example, the determination of the scene map, evaluation of virtual image position and image rendering steps in the processing unit 4 (each explained below) may all take place in parallel with each other.

It is further understood that parallel steps taking place within different components, or within the same components, may take place at different frame rates. In embodiments, the displayed image may be refreshed at a rate of 60 Hz, though it may be refreshed more often or less often in further embodiments. Unless otherwise noted, in the following description of FIG. 10, the steps may be performed by one or more processors within the head mounted display device 2 acting alone, one or more processors in the processing unit 4 acting alone, one or more processors in the hand held device 12 acting alone, or a combination of processors from two or more of device 2, unit 4 and device 12 acting in concert.

In general, the system generates a scene map having x, y, z coordinates of the environment and objects in the environment such as users, real-world objects and virtual objects. The system also tracks the FOV of each user. While users may possibly be viewing the same aspects of the scene, they are viewing them from different perspectives. Thus, the system generates each person's FOV of the scene to adjust for different viewing perspectives, parallax and occlusion of virtual or real-world objects, which may again be different for each user.

For a given frame of image data, a user's view may include one or more real and/or virtual objects. As a user turns his head, for example left to right or up and down, the relative position of real-world objects in the user's FOV inherently moves within the user's FOV. For example, plant 27 in FIG. 1 may appear on the right side of a user's FOV at first. But if the user then turns his head toward the right, the plant 27 may eventually end up on the left side of the user's FOV.

However, the display of virtual objects to a user as the user moves his head is a more difficult problem. In an example where a user is looking at a virtual object in his FOV, if the user moves his head left to move the FOV left, the display of the virtual object may be shifted to the right by an amount of the user's FOV shift, so that the net effect is that the virtual object remains stationary within the FOV.

In steps 604 and 620, the mobile display device and hand held device 12 gather data from the scene. This may be image data sensed by the depth camera 426 and RGB camera 428 of capture devices 125 and/or camera 22. This may be image data sensed the eye tracking assemblies 134, and this may be acceleration/position data sensed by the IMU 132 and IMU 511.

In step 606, the scene data is gathered by one or more of the processing units in the system 10, such as for example processing unit 4. In the following description, where a process is described as being performed by processing unit 4, it is understood that it may be performed by one or more of the processors in the system 10. In step 608, the processing unit 4 performs various setup operations that allows coordination of the image data of the capture device 125 and the camera 22. In particular, in step 608, the mobile display device and hand held device 12 may cooperate to register the position of the hand held device 12 in the reference frame of the mobile display device. Further details of step 608 will now be explained with reference to the flowchart of FIG. 11. In the following description, capture devices 125 and camera 22 may collectively be referred to as imaging devices.

One operation of step 608 may include determining clock offsets of the various imaging devices in the system 10 in a step 670. In particular, in order to coordinate the image data from each of the imaging devices in the system, it may be confirmed that the image data being coordinated is from the same time. Details relating to determining clock offsets and synching of image data are disclosed in U.S. patent application Ser. No. 12/772,802, entitled “Heterogeneous Image Sensor Synchronization,” filed May 3, 2010, and U.S. patent application Ser. No. 12/792,961, entitled “Synthesis Of Information From Multiple Audiovisual Sources,” filed Jun. 3, 2010, which applications are incorporated herein by reference in their entirety. In general, the image data from capture device 125 and the image data coming in from camera 22 are time stamped off a single master clock, for example in processing unit 4. Using the time stamps for such data for a given frame, as well as the known resolution for each of the imaging devices, the processing unit 4 may determine the time offsets for each of the imaging devices in the system. From this, the differences between, and an adjustment to, the images received from each imaging devices may be determined.

Step 608 further includes the operation of calibrating the positions of imaging devices with respect to each other in the x, y, z Cartesian space of the scene. Once this information is known, one or more processors in the system 10 is able to form a scene map or model, and identify the geometry of the scene and the geometry and positions of objects (including users) within the scene. In calibrating the image data of imaging devices to each other, depth and/or RGB data may be used. Technology for calibrating camera views using RGB information alone is described for example in U.S. Patent Publication No. 2007/0110338, entitled “Navigating Images Using Image Based Geometric Alignment and Object Based Controls,” published May 17, 2007, which publication is incorporated herein by reference in its entirety.

The imaging devices in system 10 may each have some lens distortion which may be corrected for in order to calibrate the images from different imaging devices. Once image data from the various imaging devices in the system is received in step 604, the image data may be adjusted to account for lens distortion for the various imaging devices in step 674. The distortion of a given imaging device (depth or RGB) may be a known property provided by the camera manufacturer. If not, algorithms are known for calculating an imaging device's distortion, including for example imaging an object of known dimensions such as a checker board pattern at different locations within a camera's FOV. The deviations in the camera view coordinates of points in that image will be the result of camera lens distortion. Once the degree of lens distortion is known, distortion may be corrected by known inverse matrix transformations that result in a uniform imaging device view map of points in a point cloud for a given camera.

The system may next translate the distortion-corrected image data points captured by each imaging device from the camera view to an orthogonal 3-D world view in step 678. This orthogonal 3-D world view is a point cloud map of image data captured by capture device 125 and the camera 22 in an orthogonal x, y, z Cartesian coordinate system. Methods using matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000), which publication is incorporated herein by reference in its entirety. See also, U.S. patent application Ser. No. 12/792,961, previously incorporated by reference.

Each imaging device in system 10 may construct an orthogonal 3-D world view in step 678. The x, y, z world coordinates of data points from a given imaging device are still from the perspective of that imaging device at the conclusion of step 678, and not yet correlated to the x, y, z world coordinates of data points from other imaging devices in the system 10. The next step is to translate the various orthogonal 3-D world views of the different imaging devices into a single overall 3-D world view shared by the imaging devices in system 10.

To accomplish this, embodiments of the system may next look for key-point discontinuities, or cues, in the point clouds of the world views of the respective imaging devices in step 682. Once found, the system identifies cues that are the same between different point clouds of different imaging devices in step 684. Once the system is able to determine that two world views of two different imaging devices include the same cues, the system is able to determine the position, orientation and focal length of the two imaging devices with respect to each other and the cues in step 688. In embodiments, the capture devices 125 and camera 22 will not share the same common cues. However, as long as they have at least one shared cue, the system may be able to determine the positions, orientations and focal lengths of the capture devices 125 and camera 22 relative to each other and a single, overall 3-D world view.

Various known algorithms exist for identifying cues from an image point cloud. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630. (2005), which paper is incorporated by reference herein in its entirety. A further method of detecting cues with image data is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image,” issued Mar. 23, 2004, which patent is incorporated by reference herein in its entirety. Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002), which paper is incorporated by reference herein in its entirety.

In step 684, cues which are shared between point clouds from the imaging devices are identified. Conceptually, where a first group of vectors exist between a first camera and a group of cues in the first camera's Cartesian coordinate system, and a second group of vectors exist between a second camera and that same group of cues in the second camera's Cartesian coordinate system, the two systems may be resolved with respect to each other into a single Cartesian coordinate system including both cameras. A number of known techniques exist for finding shared cues between point clouds from two or more cameras. Such techniques are shown for example in Arya, S., Mount, D. M., Netanyahu, N. S., Silverman, R., and Wu, A. Y., “An Optimal Algorithm For Approximate Nearest Neighbor Searching Fixed Dimensions,” Journal of the ACM 45, 6, 891-923 (1998), which paper is incorporated by reference herein in its entirety. Other techniques can be used instead of, or in addition to, the approximate nearest neighbor solution of Arya et al., incorporated above, including but not limited to hashing or context-sensitive hashing.

Where the point clouds from two different imaging devices share a large enough number of matched cues, a matrix correlating the two point clouds together may be estimated, for example by Random Sampling Consensus (RANSAC), or a variety of other estimation techniques. Matches that are outliers to the recovered fundamental matrix may then be removed. After finding a group of assumed, geometrically consistent matches between a pair of point clouds, the matches may be organized into a group of tracks for the respective point clouds, where a track is a group of mutually matching cues between point clouds. A first track in the group may contain a projection of each common cue in the first point cloud. A second track in the group may contain a projection of each common cue in the second point cloud. The point clouds from different cameras may be resolved into a single point cloud in a single orthogonal 3-D real-world view.

The positions and orientations of the imaging devices are calibrated with respect to this single point cloud and single orthogonal 3-D real-world view. In order to resolve the two point clouds together, the projections of the cues in the group of tracks for two point clouds are analyzed. From these projections, the system can determine the perspective of capture devices 125 with respect to the cues, and can also determine the perspective of camera 22 with respect to the cues. From that, the system can resolve the point clouds into an estimate of a single point cloud and single orthogonal 3-D real-world view containing the cues and other data points from both point clouds. Once this is done, the system can determine the relative positions and orientations of the imaging devices relative to the single orthogonal 3-D real-world view and each other. The system can further determine the focal length of each camera with respect to the single orthogonal 3-D real-world view.

While the above describes one method for registering the head mounted display device 2 and hand held device 12 in a single scene map, it is understood that the relative positions of the head mounted display device 2 and hand held device 12 may be determined by other methods in further embodiments. As one further example, one or both of the head mounted display device 2 and hand held device 12 may include markers which can be detected and tracked by the other device once in the FOV of the other device.

Referring again to FIG. 10, once the system is calibrated in step 608, a scene map may be developed in step 610 identifying the geometry of the scene as well as the geometry and positions of objects within the scene. In embodiments, the scene map generated in a given frame may include the x, y and z positions of users, real-world objects and virtual objects in the scene. The information is obtained during the image data gathering steps 604 and 620, and is calibrated together in step 608. Using the information determined in steps 608 and 610, the hand held device 12 is able to determine its position in the scene map in step 624.

In step 614, the system determines the x, y and z position, the orientation and the FOV of each head mounted display device 2 for users within the system 10. Further details of step 614 are provided in U.S. patent application Ser. No. 13/525,700, entitled, “Virtual Object Generation Within a Virtual Environment,” which application is incorporated by reference herein in its entirety.

In step 628, the hand held device 12 or processing unit 4 may check for user interaction with a virtual object using the hand held device 12 as described above. If such interaction is detected, the new position and/or appearance of the affected virtual object is determined and stored in step 630, and used by the processing unit 4 in step 618.

In step 618, the system may use the scene map of the user position, FOV and interaction of the hand held device 12 with virtual objects to determine the position and appearance of virtual objects at the current time. These changes in the displayed appearance of the virtual object are provided to the system, which can then update the orientation, appearance, etc. of the virtual three-dimensional object from the user's perspective in step 618.

In step 634, the processing unit 4 (or other processor in system 10) may cull the rendering operations so that just those virtual objects which could possibly appear within the final FOV of the head mounted display device 2 are rendered. The positions of other virtual objects may still be tracked, but they are not rendered. It is also conceivable that, in further embodiments, step 634 may be skipped altogether and the entire image is rendered.

The processing unit 4 may next perform a rendering setup step 638 where setup rendering operations are performed using the scene map and FOV determined in steps 610, 612 and 614. Once virtual object data is received, the processing unit may perform rendering setup operations in step 638 for the virtual objects which are to be rendered in the FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

The system may next determine occlusions and shading in the user's FOV in step 644. In particular, the screen map has x, y and z positions of objects in the scene, including moving and non-moving objects and the virtual objects. Knowing the location of a user and their line of sight to objects in the FOV, the processing unit 4 (or other processor) may then determine whether a virtual object partially or fully occludes the user's view of a visible real-world object. Additionally, the processing unit 4 may determine whether a visible real-world object partially or fully occludes the user's view of a virtual object. Occlusions may be user-specific. A virtual object may block or be blocked in the view of a first user, but not a second user. Accordingly, occlusion determinations may be performed in the processing unit 4 of each user.

In step 646, the GPU 322 of processing unit 4 may next render an image to be displayed to the user. Portions of the rendering operations may have already been performed in the rendering setup step 638 and periodically updated.

In step 650, the processing unit 4 checks whether it is time to send a rendered image to the head mounted display device 2, or whether there is still time for further refinement of the image using more recent position feedback data from the hand held device 12 and/or head mounted display device 2. In a system using a 60 Hertz frame refresh rate, a single frame is about 16 ms.

If time to display and updated image, the images for the one or more virtual objects are sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 658.

On the other hand, where it is not yet time to send a frame of image data to be displayed in step 650, the processing unit may loop back for more updated data to further refine the predictions of the final FOV and the final positions of objects in the FOV. In particular, if there is still time in step 650, the processing unit 4 may return to steps 604 and 620 to get more recent sensor data from the head mounted display device 2 and hand held device 12.

The processing steps 604 through 668 are described above by way of example only. It is understood that one or more of these steps may be omitted in further embodiments, the steps may be performed in differing order, or additional steps may be added.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a virtual environment, the virtual environment being coextensive with a real-world space, the system comprising:
a display device at least in part assisting in the determination of a scene map including one or more virtual objects, the display device including a display unit for displaying a virtual object of the one or more virtual objects in the virtual environment; and
an accessory capable of being moved in the real-world space independently of the display device, the accessory registered within the same scene map as the display device.

2. The system of claim 1, wherein the accessory is a hand held device.

3. The system of claim 2, wherein the hand held device includes an inertial measurement unit for providing at least one of acceleration or velocity data of the hand held device as it is moved in the real-world space.

4. The system of claim 1, wherein the accessory includes an imaging device and a puck.

5. The system of claim 4, wherein the imaging device is a first imaging device, the display device including a second imaging device, the first and second imaging devices enabling registration of the display device and accessory in the same scene map.

6. The system of claim 4, wherein the puck includes an inertial measurement unit for providing at least one of acceleration or velocity data of the accessory as it is moved in the real-world space.

7. The system of claim 4, wherein the puck includes a cellular telephone.

8. A system for presenting a virtual environment, the virtual environment being coextensive with a real-world space, the system comprising:
a display device at least in part assisting in the determination of a scene map including one or more virtual objects, the display device including a display unit for displaying a virtual object of the one or more virtual objects in the virtual environment; and
an accessory registered within the same scene map as the display device, the accessory capable of interacting with the virtual object.

9. The system of claim 8, the accessory interacting with the virtual object by selecting the virtual object using a virtual ray displayed on the display device, the virtual ray displayed as extending from the accessory to the virtual object.

10. The system of claim 9, the virtual ray generated upon selection of a real or graphical control on an input pad of the accessory.

11. The system of claim 9, the accessory interacting with the selected virtual object by causing the virtual object to be displayed as: moving closer to the accessory along the virtual ray, moving away from the accessory along the virtual ray, moving the up, down, left or right relative to the virtual ray, increasing or decreasing in size or rotating.

12. The system of claim 9, the accessory interacting with the selected virtual object by at least one of copying the virtual object, pasting a duplicate of the virtual object within the virtual environment, removing the virtual object from the virtual environment, altering a color, texture or shape of the virtual object, or animating the virtual object.

13. The system of claim 8, the accessory interacting with the virtual object by selecting the virtual object upon the accessory contacting a surface of the virtual object or being positioned within an interior of the virtual object.

14. The system of claim 13, the accessory interacting with the selected virtual object by displaying the virtual object as moving with the accessory and being released at a new location within the virtual environment.

15. The system of claim 8, the accessory interacting with the virtual object by displaying the virtual object as moving away from the accessory upon the accessory contacting a surface of the virtual object.

16. The system of claim 8, the accessory configured as a shooting device, the accessory interacting with the virtual object by aiming the accessory at the virtual object and shooting at the virtual object.

17. A method of direct interaction with virtual objects within a virtual environment, the virtual environment being coextensive with a real-world space, the method comprising:
(a) defining a scene map for the virtual environment, a position of a virtual object being defined within the scene map;
(b) displaying the virtual object via a display device, a position of the display device being registered within the scene map; and
(c) directly interacting with the virtual object displayed by the display device using a hand held device, a position of the hand held device being registered within the scene map.

18. The method of claim 17, wherein said step (a) of defining the scene map comprises the step of the display device and hand held object cooperating together to define the scene map and register the positions of the display device and hand held device within the scene map.

19. The method of claim 17, the display device including a first imaging device, and the hand held device including a second imaging device, wherein said step (a) of defining the scene map comprises the step of the first and second imaging devices identifying common points in the fields of view of the first and second imaging devices, the identification of common points enabling registration of the display device and hand held device in the same scene map.

20. The method of claim 17, said step (c) of directly interacting with the virtual object comprising one of:
selecting the virtual object using a virtual ray displayed by the display device as emanating from the hand held object, and manipulating the hand held object so that the display device displays the virtual ray as intersecting the virtual device, or
selecting the virtual object by positioning the hand held object in real-world space at which the virtual object is displayed.
